(19) United States
(12) Patent Application Publication
(10) Pub. No.: US 2002/0097447 A1
(43) Pub. Date: Jul. 25, 2002

(54) User directed intelligent repeat image feature

(75) Inventors: David S. Matthews, Rochester, NY (US); John F. Whiting, Webster, NY (US); William C. Emerson, Rochester, NY (US)

Correspondence Address: LAHIVE & COCKFIELD, 28 STATE STREET, BOSTON, MA, 02109, US

(73) Assignee: Xerox Corporation

(21) Appl. No.: 09/769,926

(22) Filed: Jan. 25, 2001

(51) Int. Cl. H04N 1/387

(52) U.S. Cl. 358/450

(57) ABSTRACT

A method and apparatus for an image forming system enabling an intelligent repeat image feature is disclosed. The intelligent repeat image feature enables a user to submit an image, scanned or otherwise, and manipulate that image to result in an output image containing repeated enlarged/reduced copies of the original image on a single printing medium.

### FIELD OF THE INVENTION

The invention relates to an image forming system suitable for reproducing, forming, or producing an image on a printing medium. The invention more particularly relates to the image forming system having the capability to copy an image and automatically enlarge or reduce said image in order for a user entered number of reproductions of the image to fit on a single printing medium

### BACKGROUND OF THE INVENTION

Different technologies available in current image forming systems scan an image, manipulate that image, and print a variety of versions of that image on a printing medium. One example type of image forming system is known as an electronic printing system, and is common for commercial reproduction or copying systems.

An electronic printing system typically employs a combination of basic components. These components include a scanner for scanning image-containing documents, conversion electronics for converting the image to image signals or pixels, and a printer component for outputting images on a printing medium. The electronic printing system can store the image signals or pixels, in the form of image data, and subsequently read the image data successively to the printer component for formation of images on the printing medium, such as a piece of paper.

The user of such an electronic printing system often desires to scan a document or image and modify the resulting scanned image in a variety of ways prior to printing that scanned image on a printing medium. Some known varieties of image manipulation include enlargement or reduction of image size, lightening or darkening of image tone, adjustment of image contrast, adjustment of image resolution, shrink-to-fit, and black and white vs. color printing. The different methods by which the user can manipulate the resulting image allow the user to have greater creative freedom in forming a resulting image that matches predetermined criteria.

One common task in this day of modem image forming technology is the enlargement, or reduction, and subsequent repetition of a single image on a single printing medium. Suppose, for example, that a user obtains an image and desires to form a document that includes a plurality of replications of that image. One method of creating such a document is to copy the image onto multiple separate sheets of paper and cut and paste multiple blocks containing the image onto a single sheet. If the image is too big to fit on the single sheet in the number of copies desired, the user first reduces the image through a copy reduction feature, and then copies, cuts, and pastes the plurality of reduced images onto a single sheet. The user then copies the physically cut and paste single sheet onto a final single sheet version containing the multiple blocks of the reduced original image. This process is time consuming, requires excess use of paper, and often results in poor image quality.

One can carry out a similar process in a digital manner on a word processor in which “cut and paste” operations are built into the system software, but only if the image to be replicated can be portrayed in a compatible manner. Through trial and error, a user can reduce a digital image, replicate the image the desired number of times, and attempt to fit the collection of image replications on one printed sheet. This process may require several attempts at reducing and enlarging the original image, and then laying out replicate copies of the image across the page until the desired number of images properly fits on the page. However, if the image to be replicated and multiplied is not already in digital form, if the user does not have access to a word processor or other similar software package, or if some other factor precludes the above-described process, the “cut and paste” operation of the word processor will not work. This process is time consuming, is confined to word processor images, and is relatively inefficient.

### SUMMARY OF THE INVENTION

There exists in the art a need for an image forming system containing a user directed intelligent repeat image feature that enables a user to submit an image, scanned or otherwise, and reduce/enlarge that image to result in an output image containing repeated, modified copies of the original image on a single printing medium, such as an output document or paper sheet. The present invention is directed toward further solutions in this art.

An image forming system includes a feature having a method of forming an image in accordance with one example embodiment of the present invention. The method includes the steps of obtaining instructions relating to image formation. This is followed by obtaining scanned image data relating to a scanned image and based at least partially on the instructions. The image forming system then forms an image comprising the scanned image, repeated one or more times on a single printing medium, as directed by the instructions.

The step of obtaining instructions, according to one aspect of the invention, includes the step of communicating with a user and receiving user instructions as to the formation of the image. The step of obtaining instructions can further include receiving instructions as to which specific portion of the scanned image is to be formed. The instructions, according to a further aspect of the invention, can contain information as to the number of replications desired.

The step of obtaining scanned image data can include the step of scanning at least a portion of an image to be printed. The scanned image data can originate from a remote device containing the original scanned image data.

The image forming step, according to a further aspect of the present invention, can include printing the scanned image in repeated fashion up to a predetermined number in concurrence with the instructions.

The method, according to further aspects of the present invention, can include further features such as automatically enlarging or reducing the scanned image to result in the predetermined number of repeated scanned images substantially filling a single printing medium; or automatically detecting dimensions of the scanned image and automatically determining the predetermined number of repeated scanned images possible for printing on a single printing medium.

### BRIEF DESCRIPTION OF THE DRAWINGS

The aforementioned features and advantages, and other features and aspects of the present invention, will become better understood with regard to the following description and accompanying drawings, wherein:

FIG. 1 is a perspective illustration of an image forming system suitable for supporting a feature according to teachings of the present invention;

FIG. 2 is a schematic illustration of the example image forming system of FIG. 1,

FIG. 3 is a diagrammatic illustration of a scanned image, according to one aspect of the present invention;

FIG. 4 is a diagrammatic illustration of an output image based on the scanned image of FIG. 3, according to one aspect of the present invention;

FIG. 5 is a diagrammatic illustration of another output image resulting from the scanned image of FIG. 3, according to one aspect of the present invention; and

FIGS. 6A through 6E show a flowchart illustrating a stepwise application in accordance with one aspect of the present invention, as well as sample user interface images.

### DETAILED DESCRIPTION OF THE INVENTION

The present invention generally relates to an image forming system that includes a user directed intelligent repeat image feature allowing the user to copy a predetermined portion of an original document containing an image, and reproduce multiple reproductions or replications of that image, reduced or enlarged, on a printing medium in a manner in compliance with user instructions. The intelligent repeat image feature is in addition to other known features in current image forming technology. This intelligent repeat image feature is different from a feature known to those of ordinary skill in the art as “N-Up” because it scans only a predetermined portion of an input document containing the image and enlarges or reduces the original image to place a predetermined number of copies of the image on a single output paper. Contrarily, “N-Up” scans an entire surface of the input document and reduces the image contained thereon, and the surrounding white-space, to a size enabling a fit of a predetermined number of copies on a single output paper. The term “white-space” as used herein means space on a document that does not contain an identifiable image.

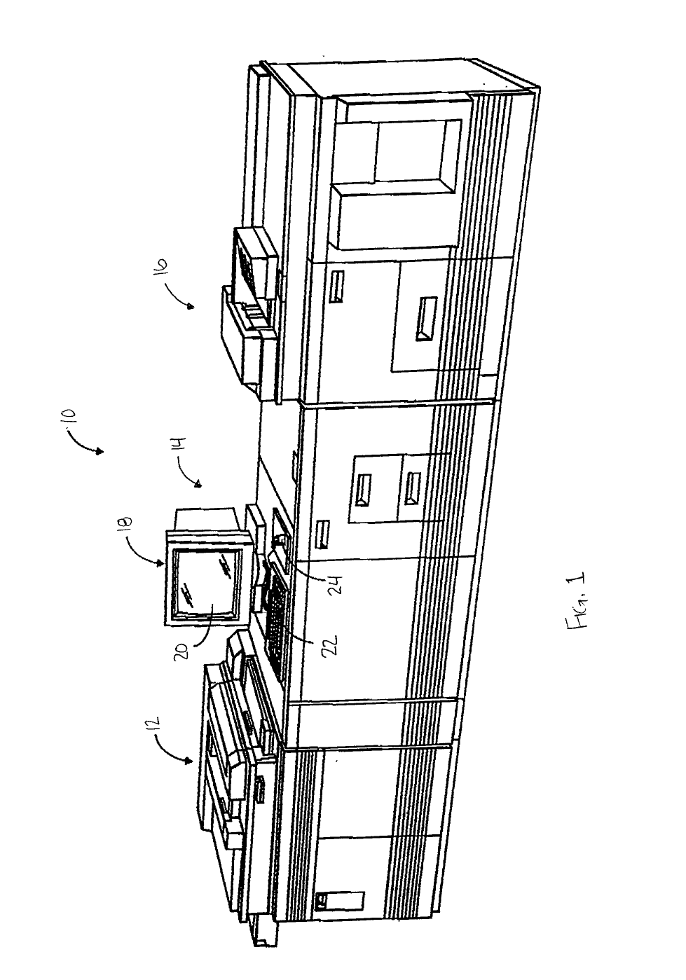

FIGS. 1 through 6E, wherein like parts are designated by like reference numerals throughout, illustrate an example embodiment of an image forming system according to the teachings of the present invention. Although the present invention will be described with reference to the example embodiments illustrated in the figures, it should be understood that many alternative forms can embody present invention. One of ordinary skill in the art will additionally appreciate different ways to alter the parameters of the embodiments disclosed, such as the size, shape, or type of elements or materials, in a manner still in keeping with the spirit and scope of the present invention.

FIG. 1 illustrates an example image forming system 10. Image forming systems can include a collection of different technologies, such as electrophotographic, electrostatic, electrostatographic, ionographic, acoustic, laser, ink jet, and other types of image forming or reproducing systems that are adapted to capture and/or store image data associated with a particular object, such as a document, and reproduce, form, or produce an image.

An electronic printing system serves as an example image forming system 10 to illustrate the basic image forming process and provide an exemplar structure with which to associate the feature of the present invention. The electronic printing image forming system 10 is broken into several sections. There is a scanner section 12, a controller section 14, and a printer section 16. Image data enters the image forming system 10 at the scanner section 12. The controller section 14 includes a user interface 18. The user interface 18 illustrated includes an interactive touchscreen 20 coupled with a keyboard 22 and a mouse 24 for user input. The user interface 18 can include other interface mechanisms, such as track ball, joystick, stylus, and the like. Documents formed by the image forming system 10 exit the system in a completed format from the printer section 16.

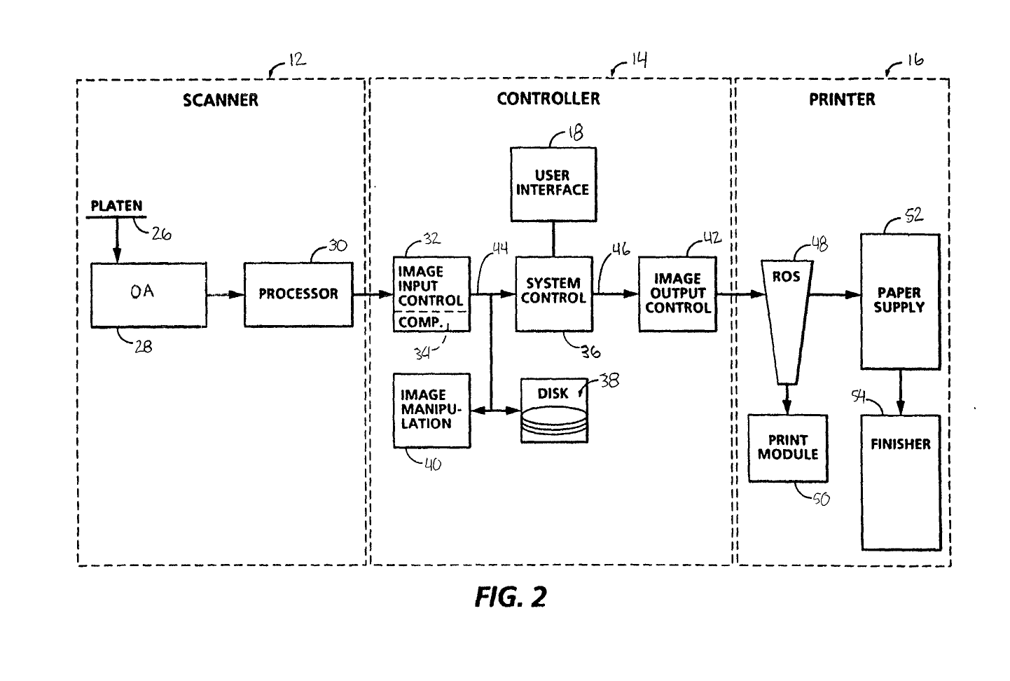

FIG. 2 illustrates some of the primary components that comprise the electronic printing system. This illustration shows the scanner section 12, the controller section 14, and the printer section 16. The scanner section 12 includes a transparent platen 26 upon which a user places an input document to be scanned. An optical assembly 28 occupies a location beneath the transparent platen 26, and includes such elements as lenses and mirrors (not shown) which cooperate to focus light images reflected from the platen 26 and the document being scanned thereon. The optical assembly 28 provides image signals, or pixels representative of the image scanned, to the processor 30, which processes the image signals and provides image data to the image input controller 32. The image signals can alternatively originate from another source outside of the image forming system 10, e.g., signals transmitted through a wire or wireless connection to the processor 30.

The image compressor/processor 34 of the image input controller 32 compresses the scanned image data input as it moves from the processor 30 of the scanner section 12 to the controller section 14. The image manipulation section 40, the system controller 36, and user interface 18 work together to process the image data segmenting the data into slices N scan lines wide, each slice having a slice pointer. The compressed image data, together with slice pointers and any related image descriptors providing image specific information (such as height and width of the document in pixels, the compression method used, pointers to the compressed image data, and pointers to the image slice pointers), exist in an image file. A random access memory, or RAM, temporarily stores the image files, which represent different print jobs. The temporary storage is pending transfer to main memory 3 8 where the data remains pending use. A plurality of different buses, such as buses 44, and 46, connects each of the components within the controller section 14 as illustrated in FIG. 2.

User interface 18 includes the interactive touchscreen 20, and keyboard 22, and the mouse 24 (see FIG. 1). The user interface 18 interfaces with the user, enabling the user to program print jobs and other instructions, to obtain system operating information, instructions, programming information, diagnostic information, and other desired and programmed information. The user can obtain feedback from the user interface 18 regarding a reduction/enlargement and a layout of proposed output documents based on input image information. Items displayed on the touchscreen 20, such as data information and icons, are actuated by either touching the displayed item on the touchscreen 20, or by using the keyboard 22 or the mouse 24 to manipulate the information on the touchscreen 20 and enter the desired instructions for queries. The user can alternatively utilize other interface devices, such as joysticks, track balls, and styluses, depending on the particular image forming system.

The image data returns to main memory 38, proceeds to the user interface 18 for display on the touchscreen 20, or proceeds to the image output controller 42 for final printing, following the image processing step. The image output controller 42 decompresses the image data and processes the data for printing. The raster output scanner 48 receives the image data from the image output controller 42 and works in conjunction with the print module 50 to form desired output images on printing mediums. The printing mediums can take such form as paper found in the paper supply 52, which ultimately outputs the final printed product through the finisher 54.

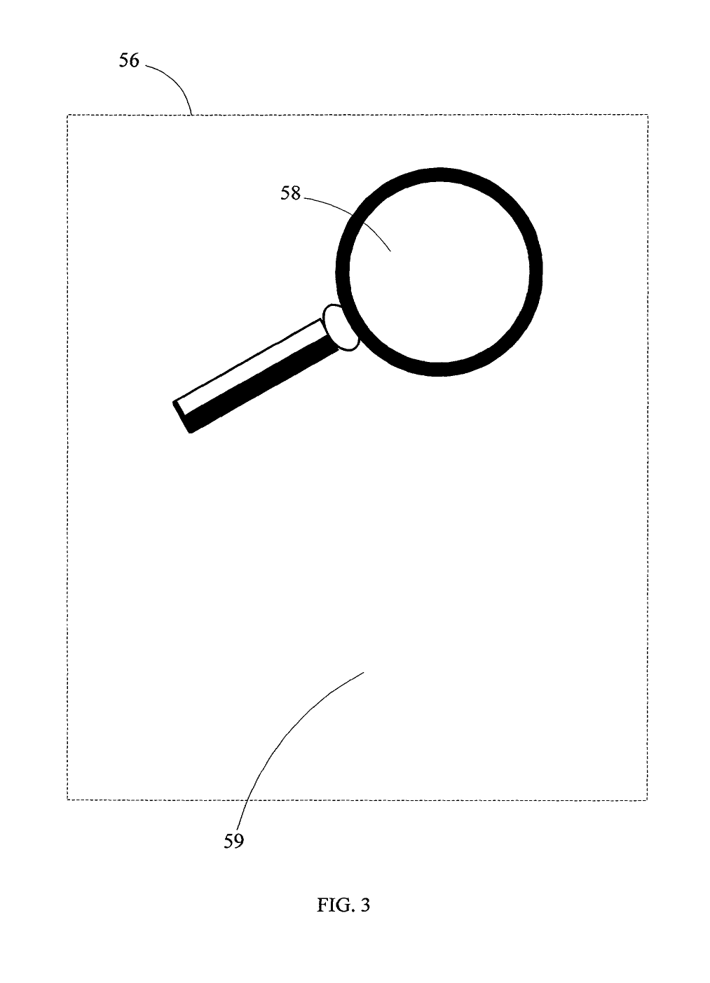

FIG. 3 illustrates an example input document 56, which contains an input image 58. The input image 58, for illustrative purposes, is a magnifying glass, but can be any reproducible image. White-space 59 surrounds the input image 58, and also substantially fills a lower half of the input document 56. The teachings of the present invention allow the user to insert the input document 56 into the image forming system 10. The user then utilizes the user interface 18 to instruct the image forming system 10 to scan the specific input image 58 on a portion of the input document 56. The image forming system 10, through various processes known to one of ordinary skill in the art, focuses the scanning process only on the image 58 and not on the surrounding whitespace 59. This results in a data file containing image data on the input image 58, absent superfluous data from the surrounding white-space 59 areas. The user interface 18 then presents the user with a variety of ways in which to modify the input image 58 and produce an output document 60. The fact that the image data contains information pertaining to the image 58 and does not include the surrounding white-space 59 as part of the image, enables the subsequent steps and features of the present invention.

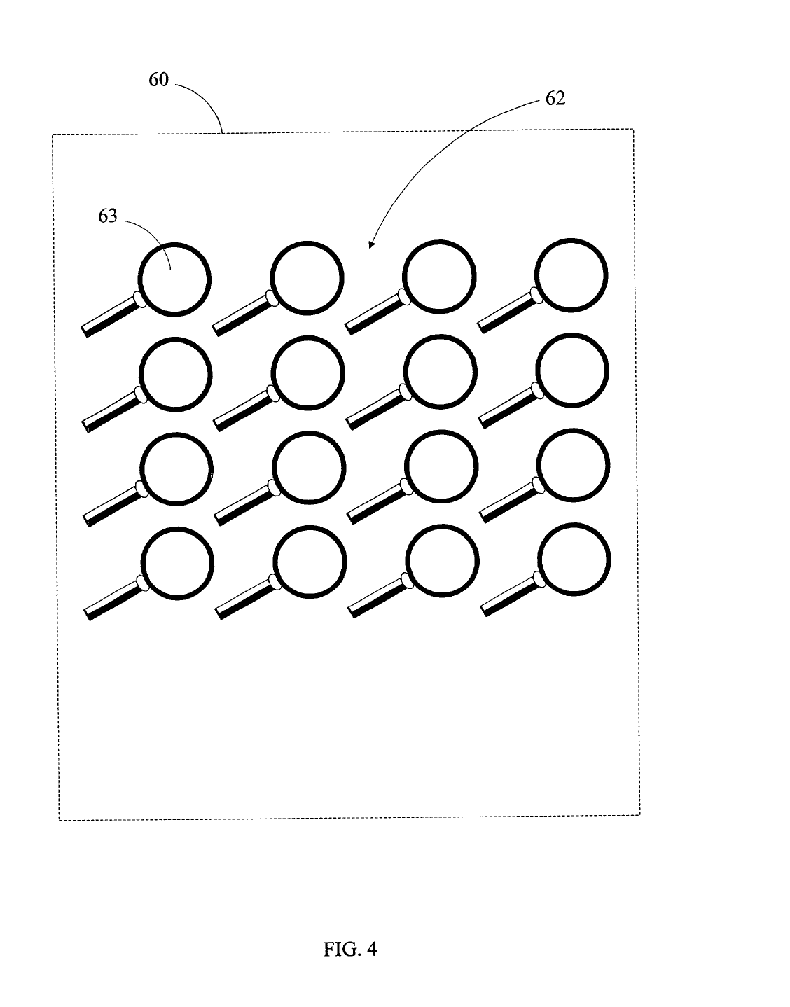

FIG. 4, for example, illustrates one possible output document 60, which contains an output image 62. The original input image 58, in reduced format and replicated sixteen times and printed in a 4×4-grid pattern on the output document 60, forms the output image 62. This output document 60 is the result of a user submitting the original input image 58 to the image forming system 10, and entering instructions. The instructions, in this example, consisted of a direction to take the input image 58, and replicate that image sixteen times in a manner that fits on the output document 60. The image forming system 10 reduces the original input image 58 into reduced input image 63, to enable replication of the input image 58 sixteen times on the output document 60. The image forming system 10, according to the teachings of the present invention, receives the image data and the user instructs the replication of the input image 58a selected number of times. The image forming system 10 then automatically calculates the reduction of the input image 58 and the arrangement of the reduced input images 63 in the output image 62, and prints the output document 60 as shown. This intelligent repeat image feature allows the user to copy a portion of the original input document 56 containing only the input image 58 without any extraneous white-space, and fill the output document 60 with the instructed number of modified copies of the input image 58.

This intelligent repeat image feature differs from a feature known as “N-Up,” which scans the entire input document 56, including the white space beneath the input image 58, reduces the entire input document 56, and reproduces a number of shrunken images on the output document 60. This approach makes the input image 58 smaller than desired, possibly unreadable, and inclusive of the unwanted white-space. The image forming system 10 has the ability to scan the input document 56 to determine where the actual image of the input image 58 resides on the input document 56. That specific portion of the input document 56 where the input image 58 resides is the only portion that is scanned and reproduced on the subsequent output document 60. The surrounding white-space, e.g., the white-space 59 of FIG. 3, is discarded as not being part of the image. Therefore, when reductions or enlargements are required, they are based solely on the actual image and not the image together with the surrounding white-space.

The following example further distinguishes the “N-Up” feature from the intelligent repeat image feature of the present invention, and highlights the differences between each feature. The example begins with an 8½×11-inch document containing a 2×2-inch image. The user instructs the image forming system to produce a single document with, for example, ten copies of the 2×2-inch image. The “N-Up” feature takes the 8½×11-inch document and reduces the entire 8½×11-inch document, including white-space surrounding the 2×2-inch image, to one-tenth of its original size. The 2×2-inch image, to be clear, also reduces by one-tenth. The “N-Up” feature then prints the reduced images onto the output paper, with ten copies of the image. Contrarily, the intelligent repeat image feature, in this example, takes the original 8½×11-inch document containing the 2×2-inch image and automatically scans only the 2×2-inch image. The intelligent repeat image feature then determines whether the scanned image can fit on the output paper the number of times instructed by the user. The image multiplier, in this instance, determines that ten full sized 2×2-inch images cannot fit unmodified onto a single 8½×11-inch document. The method of the present invention therefore reduces the 2×2 images a sufficient amount and places ten reduced replications of the 2×2-inch image on the single output paper in the final printing.

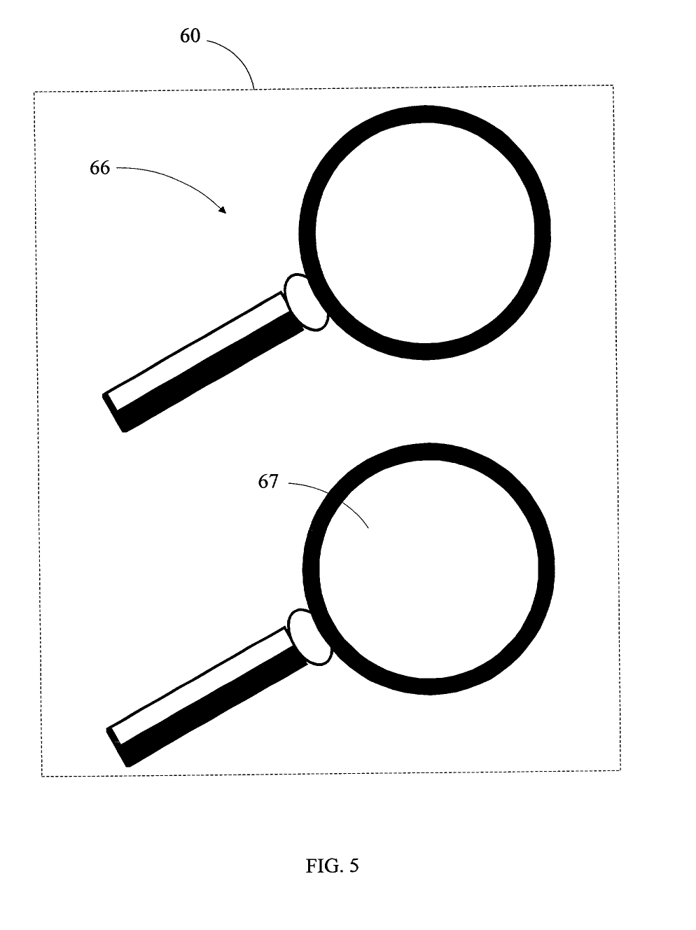

FIG. 5 illustrates a different output document 64 having the same input document 56 and input image 58 as in the previous example. The resulting output document 64 in this figure contains the resulting output image 66, defined by instructions entered by the user. The output document 64 illustrated is the result of the user entering a desired number of two enlarged replications 67 of the original input image 58. The two replications 67 of the input image 58 are enlarged to the point that they can still fit on the output document 64. The user has chosen, through the user interface 18, to place each reproduction of the input image 58 in one half of the output document 64. The resulting output paper or document 64 therefore contains the two, enlarged replications of the magnifying glass image 58, absent the significant white-space 59 of the original input document 56.

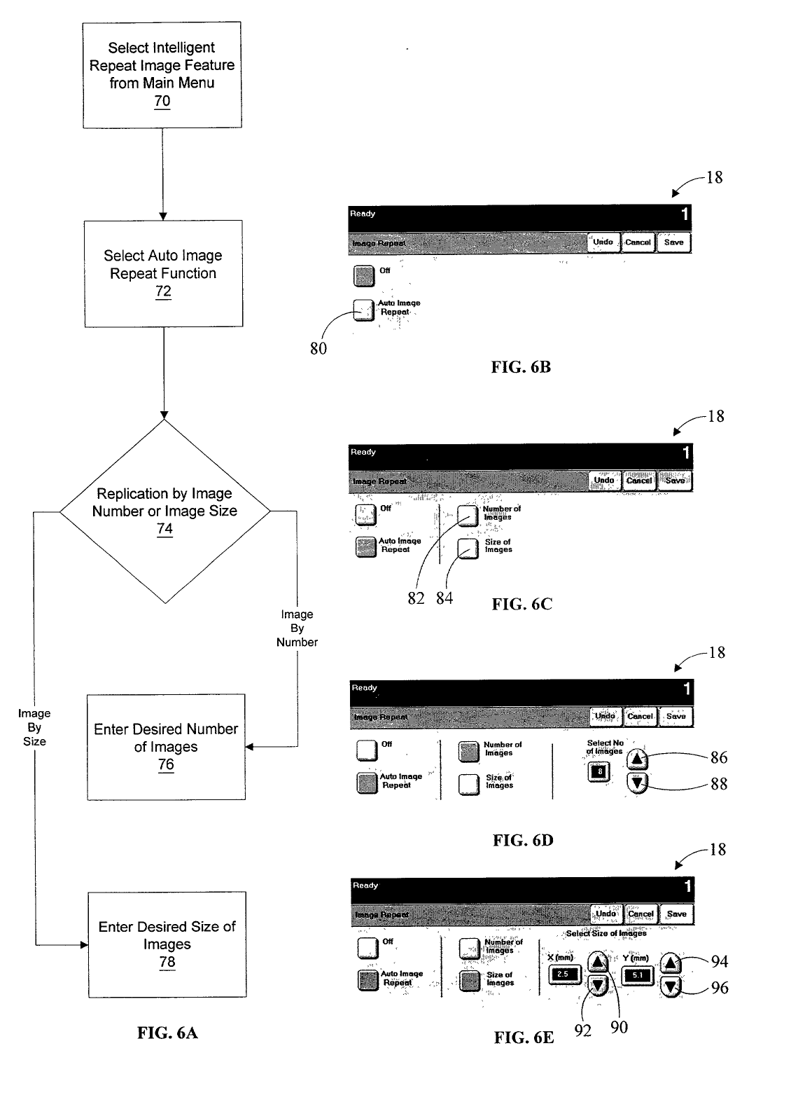

An example execution of the intelligent repeat image feature according to the teachings of the present invention executes as follows and as illustrated in FIG. 6A, with corresponding user interface 18 images in FIGS. 6B through 6E. The user first selects the intelligent repeat image feature from the user interface 18 main menu (main menu not shown) (step 70). The user selects the auto image repeat function (step 72) by pressing the “Auto Image Repeat” button 80 of the user interface 18 as shown in FIG. 6B. The user, (in step 74) can choose to enter a desired number images to replicate on each output page, or choose to enter a desired size of images to replicate on each output page. If the user chooses to proceed according to the number of images, the user presses the “Number of Images” button 82 of the user interface 18 shown in FIG. 6C. The user then increases or decreases the desired number of images per page (step 76) by repeatedly pressing the up arrow 86 or the down arrow 88, accordingly, of the user interface 18 shown in FIG. 6D. If the user chooses to proceed according to the size of images, the user presses the “Size of Images” button 84 of the user interface 18 shown in FIG. 6C. The user then enters the dimensions desired (step 78) by repeatedly pressing the up arrow 90 or the down arrow 92 of the “X” coordinate dimensions, and the up arrow 94 or the down arrow 96 of the “Y” coordinate dimensions, on the user interface 18 shown in FIG. 6E. The user can then proceed with other known copier procedures such as number of copies, and the like, prior to entering “Start”, or an equivalent thereof, on the control panel or user interface 18 of the image forming system 10 to begin the image forming process. If, for example, the user enters the desired number of images per page as “10”, and the desired number of copies as “3”, then the output is three sheets of paper with each paper bearing ten images of the original input image. Any number of different combinations are possible, given the constraints of the input documents and images, and the output pages. The particular user interface 18 images illustrated, and the corresponding layout, design, and labeling, can also vary in accordance with any number of combinations and versions as understood by one of ordinary skill in the art.

This intelligent repeat image feature avoids the user having to generate, in the above example, ten separate copies of the input image, reduced, on ten separate sheets of paper; then cutting each of the images out of each sheet of paper, and pasting or taping the ten images onto a single sheet of paper for subsequent copying onto a final single sheet of paper. Thus, excess waste of paper is avoided, and the job is completed in a more efficient manner.

Numerous modifications and alternative embodiments of the invention will be apparent to those skilled in the art in view of the foregoing description. This description, accordingly, is to be construed as illustrative only and is for the purpose of teaching those skilled in the art the best mode for carrying out the invention. Details of the structure may vary substantially without departing from the spirit of the invention, and exclusive use of all modifications that come within the scope of the appended claims is reserved. It is intended that the invention be limited only to the extent required by the appended claims and the applicable rules of law.

What is claimed is:

1. A method of forming an output image in an image forming system, comprising the steps of:
receiving image data corresponding to an input image having a first set of dimensions; and
reproducing said image data a selected number of times on a printing medium to form said output image, wherein said reproduced image data in said output image has said selected number of input image reproductions having different dimensions from said first set of dimensions.

2. The method according to claim 1, further comprising the step of reducing said first set of input image dimensions to result in said different input image dimensions.

3. The method according to claim 1, further comprising the step of enlarging said first set of input image dimensions to result in said different input image dimensions.

4. The method according to claim 1, further comprising the step of obtaining instructions relating to formation of said output image.

5. The method according to claim 4, wherein said obtaining instructions step comprises a user entering said instructions through a user interface.

6. The method according to claim 4, wherein said obtaining instructions step comprises receiving instructions from a remote location.

7. The method according to claim 1, wherein said receiving image data comprises receiving a signal from a remote device containing said image data.

8. The method according to claim 1, wherein said receiving image data comprises scanning a document containing said input image.

9. The method according to claim 1, further comprising the step of automatically detecting dimensions of said input image and automatically enlarging or reducing said input image such that a predetermined number of repeated input images can fit on a single printing medium.

10. The method according to claim 9, further comprising the step of referencing the size of said printing medium when executing the automatic enlargement or reduction of said input image.

11. The method according to claim 1, further comprising the step of providing feedback to said user through a user interface, said feedback relating to size and layout of said output image.

12. An image forming system, comprising:
a printing mechanism in communication with a processor, wherein said processor receives instructions relating to an input image and instructs said printing mechanism to print a predetermined number of replications of said input image that are one of enlarged and reduced to form an output image on a single printing medium.

13. The image forming system of claim 12, wherein a user provides said instructions through a user interface.

14. The image forming system of claim 12, wherein said processor automatically determines the amount of enlargement or reduction of said input image based at least partially on a predetermined number of reproductions of said input image possible for said single printing medium.

15. The image forming system of claim 12, wherein said processor automatically reduces or enlarges a scanned image such that a predetermined number of input image reproductions substantially fills said single printing medium.

16. The image forming system of claim 12, wherein said processor can automatically reduce or enlarge a scanned image such that a predetermined number of scanned image reproductions substantially fills a predetermined portion of said single printing medium.
